(19) United States
(12) Patent Application Publication
(10) Pub. No.: US 2010/0212196 A1
(43) Pub. Date: Aug. 26, 2010

(54) PIN IMAGING APPARATUS

(76) Inventor: Peter Cmiel, Corcoran, MN (US)

Correspondence Address: Clise, Billion & Cyr, P.A., 605 U.S. Highway 169, Suite 300, Plymouth, MN, 55441, US

(21) Appl. No.: 12/392,684

(22) Filed: Feb. 25, 2009

(51) Int. Cl. G09F 19/08

(52) U.S. Cl. 40/421

(57) ABSTRACT

A pin imaging apparatus configured to secure an image formed by pins is disclosed. The pin imaging apparatus includes at least a first plate and a locking plate. A plurality of pins extends through pin holes in the first plate and the locking plate. The locking plate is movable between a locked and an unlocked position. The pins are movable through the holes by at a minimum contact with an object at an exposed end of the pins when the locking plate is positioned in an unlocked position. The pins are secured at a desired position in the holes when the locking plate is positioned in a locked position.

### BACKGROUND OF THE INVENTION

1. Field of the Invention

The present inventions relate to imaging apparatus and, more particularly, to apparatus and methods for generating and retaining an image in a pin matrix.

2. Description of the Related Art

Various iterations of pin screens have been used for generating three dimensional images of objects in a pin matrix. The pin screens have typically included a single perforated plate or dual parallel perforated plates with an array of pins extending through the plates. A clear cover may be positioned adjacent to the plates to retain the pins within the perforations in the plates. Typically, the clear cover is positioned relative to the plates in a position parallel to the surface of pin heads. The pin heads typically rest against the perforated plate and their shafts protrude from the opposite side of the pin screens and prevent the pins from sliding through the perforations passing through the perforations in one or more of the plates. In some embodiments, the pins have included heads at both ends to prevent the pins from sliding out of the perforations in two directions.

An object positioned against the end of the shafts of the pins has its image reproduced by the opposite end of the pins. Typically, the opposite end has included the heads of the pins. In certain pin screens, the image of the object is only retained in the array of pins if the pin screen is maintained in an orientation that is substantially perpendicular to the ground. That is, an orientation where the pins are substantially parallel to the ground so that the friction between the pins and the perforations retains the pins in a position established by the object. However depending on the materials and from which the pins and plates were constructed and the particular configuration of the pin screen, the pins tend to slide within the perforations at some point as the pins' orientation is moved toward vertical. Regardless of configuration, it is typically easy to disturb the impression by lightly shaking or jostling the pin screen or tipping it away from the vertical. This displacement tends first distort and, in some cases, eliminate the image created in the pin screen. In other designs, the image is only retained while the object is in contact with the ends of the pins. Accordingly, a need exists for apparatus and methods to retain images in pin screens.

Some pin screens have included various inflatable bladders and elastomeric materials that contract or expand due to inflation or the amount of tension respectively. However, such devices typically require enough space between the pins to insert inflatable rubber tubing or stretchable elastic elements which will contact the shafts of the pins to o put retention pressure on the pin shanks. Some of these devices use an inflatable diaphragm to push against the heads of the pins. Some designs similarly use a rubber element which is positioned around a portion of the pins to restrict their movement. However, these designs present a number of problems for the production of these pin screens which increase the time and cost for their manufacture. Accordingly, a need exists for apparatus and methods that provide a pin screen that may retain an image without substantially increasing the time and cost of manufacture.

Similar gauge pin arrays have been used to measure the contours of feet for the production of inner soles. These arrays produce a three dimensional impression of the sole of a foot using the displacement of pins. Such devices have used a system including inflatable tubes to press against the shafts of the pins to retain them in the desired displaced positions. However, such pneumatic devices are complex and costly. Accordingly, a need exists for a simple robust mechanism to retain the pins in a pin screen.

### SUMMARY OF THE INVENTION

Apparatus and methods in accordance with the present invention may resolve many of the needs and shortcomings discussed above and will provide additional improvements and advantages as will be recognized by those skilled in the art upon review of the present disclosure.

In certain aspects, the present inventions provide an apparatus for forming an impression of an object, comprising:

a first plate secured to a second plate at a fixed relative position, the first plate defining a plurality of first holes, the second plate defining a plurality of second holes, the plurality of first holes coaxially aligned with the plurality of second holes;

a plurality of pins positioned through the plurality of first holes and the plurality of second holes, each of the pins comprising a shaft and a head, the head positioned at a first end of the shaft, the shafts extending through the plurality of first holes and the plurality of second holes, a second end of the shaft configured to contact an object and to displace the shaft relative to the object such that the heads of the pins to form a corresponding image of the object; and

a locking plate movably secured to the first plate and the second plate, the locking plate movable between at least a locked position and an unlocked position, the locking plate defining a plurality of locking holes, the shafts of the plurality of pins extending through the plurality of locking holes, the plurality of locking holes is aligned with the plurality of first holes and the plurality of second holes when the locking plate is in the unlocked position and the plurality of locking holes is offset from the plurality of first holes and the plurality of second holes when the locking plate is in the locked position to secure the plurality of pins and to retain the corresponding image of the object.

In other aspects, the present inventions provide an apparatus for forming an impression of an object, comprising:

a first plate defining a plurality of holes;

a plurality of pins positioned within the plurality of holes, each of the pins comprising a shaft and a head, the head positioned at a first end of the shaft, each shaft extending through at least one of the plurality of holes, a second end of the shaft configured to contact an object and to displace the shaft relative to the object such that the heads of the pins to form an image of the object; and

a locking plate movably secured to the first plate, the locking plate movable between at least a locked position and an unlocked position, the locking plate defining a plurality of locking holes, the shafts of the plurality of pins extending through at least one of the plurality of locking holes, the plurality of holes is aligned with the plurality of locking holes when the locking plate is in the unlocked position to permit the pins to be positioned when contacted by an object at the second end of the shaft and the plurality of locking holes is offset from the plurality of holes when the locking plate is in the locked position to secure the plurality of pins and to retain an image of the object.

### BRIEF DESCRIPTION OF THE DRAWINGS

FIG. 1 illustrates a partial perspective view of an exemplary embodiment of a pin imaging apparatus in accordance with aspects of the present inventions with a portion of a clear cover removed to show the pins;

FIG. 2 illustrates a side view of an exemplary embodiment of a pin imaging apparatus in accordance with aspects of the present inventions;

FIG. 3 illustrates a side view of an exemplary embodiment of another pin imaging apparatus in accordance with aspects of the present inventions;

FIG. 4 illustrates a side view of an exemplary embodiment of another pin imaging apparatus in accordance with aspects of the present inventions;

FIG. 5 illustrates a side view of an exemplary embodiment of another pin imaging apparatus in accordance with aspects of the present inventions;

FIG. 6A illustrates a partial side view of an exemplary embodiment of the relationship of a first plate and a locking plate in cross-section in the locking plate in an unlocked position;

FIG. 6B illustrates a partial side view an exemplary embodiment of the relationship of a first plate and a locking plate in cross-section in the locking plate in a locked position;

FIG. 7A illustrates a partial side view an exemplary embodiment of the relationship of a first plate, a second plate and a locking plate in cross-section in the locking plate in an unlocked position;

FIG. 7B illustrates a partial side view an exemplary embodiment of the relationship of a first plate, a second plate and a locking plate in cross-section in the locking plate in a locked position;

FIG. 8A illustrates a partial top view of an exemplary embodiment of a locking plate in accordance with aspects of the present inventions;

FIG. 8B illustrates a partial top view of another exemplary embodiment of a locking plate in accordance with aspects of the present inventions;

FIG. 8C illustrates a partial top view of another exemplary embodiment of a locking plate in accordance with aspects of the present inventions;

FIG. 9A illustrates a partial cross section of an exemplary embodiment of a plate in accordance with aspects of the present invention; and

FIG. 9B illustrates a partial cross section of another exemplary embodiment of a plate having a coating in accordance with aspects of the present invention;

All Figures are illustrated for ease of explanation of the basic teachings of the present invention only; the extensions of the Figures with respect to number, position, relationship and dimensions of the parts to form the embodiment will be explained or will be within the skill of the art after the following description has been read and understood. Further, the exact dimensions and dimensional proportions to conform to specific force, weight, strength, flow and similar requirements will likewise be within the skill of the art after the following description has been read and understood.

Where used in various Figures of the drawings, the same numerals designate the same or similar parts. Furthermore, when the terms “top,” “bottom,” “up,”, “down,” “right,” “left,” “forward,” “rear,” “first,” “second,” “inside,” “outside,” and similar terms are used, the terms should be understood with reference to the structure shown in the drawings and utilized only to facilitate describing the illustrated embodiments without reference to the particularly illustrated orientations.

### DETAILED DESCRIPTION OF THE INVENTION

The present inventions provide pin imaging apparatus 10 and associated methods for generating a three dimensional image through the displacement of pins. As illustrated generally throughout the Figures, the pin imaging apparatus 10 includes at least a first perforated plate 12, a locking plate 16 and a plurality of pins 18 extending through both the first perforated plate 12 and the locking plate 16. In certain aspects, a second perforated plate 14 may also be provided. The perforated plates include a plurality of pin holes 30. The pin holes 30 are configured to slidably receive pins 18. The locking plate 16 is movably secured to the first perforated plate 12 and, when present, the second perforated plate 14 to permit the movement of locking plate 16 between at least an unlocked position and a locked position. In the unlocked position, the pins 18 are slidably secured within the perforations. In the locked position, the pins 18 are secured in a position fixed relative to the first perforated plate 12, the locking plate 16 and, when present, the second plate 14. Accordingly, the plates may cooperate to retain an image impressed by an object 100 upon the pins 18 by securing the pins 18 in a position that the impressed image.

The Figures generally illustrate various embodiments of pin imaging apparatus 10 including aspects of the present inventions. The particular exemplary embodiments of the pin imaging apparatus 10 illustrated in the figures have been chosen for ease of explanation and understanding of various aspects of the present inventions. These illustrated embodiments are not meant to limit the scope of coverage but instead to assist in understanding the context of the language used in this specification and the appended claims. Accordingly, variations of pin imaging apparatus 10 for producing images with displaced pins different from the illustrated embodiments may be encompassed by the appended claims.

The pin image apparatus 10 includes a plurality of pins 18 extending through a series of plates arranged substantially parallel to one another. The plates include at least a first plate 12 and a locking plate 16. The plates may also include a second plate 14 and, in other embodiments, may include additional plates (not shown). A cover 20 may also be provided. In certain aspects, the cover 20 may be configured to prevent the pins 18 from fully disengaging from the pin holes 30. In certain embodiments, the cover 20 may take the form of a clear plate.

The plurality of pins 18 are generally positioned through a plurality of pin holes 30 through the plates. The pins 18 are generally positioned so that the longitudinal axes of each of the pins 18 are substantially parallel to the other pins 18. The plurality of pins 18 may comprise one or more heads 38 and a shaft 28. The pins 18 typically include a shaft 28 with a head 38 positioned at one end of the shaft 28. In certain aspects, the pins may have a head 38 positioned at both ends of the shaft 28. The heads 38 of pins 18 may be sized to prevent the passage of a head 38 through the associated pin hole 30. The head 38 may also be configured such that a lower aspect of the head 38 may rest on an upper surface of one of the plates. In certain embodiments, the heads 38 may be of a diameter larger than the diameter of the pin holes 30 to prevent the pins 18 from disengaging the pin holes 30. The shaft 28 of the pins 18 may be of a diameter that allows the pins 18 to slide freely along the hole axes of the pin holes 30. The shafts 28 may be of a material that allows the shafts 28 to be deformed when the locking plate is moved to the locked position. In certain embodiments, the material from which the pins 18 formed may be a plastic or a metal. When plastic, the material of the pins may be a nylon, a polyethylene, a polycarbonate, a polypropylene, among others for example. In some embodiments, the pins 18 are formed from a rubber material. In some embodiments the pins 18, including the shafts 28 may be made from a material that is flexible and/or resilient so that the pins, including the shafts are flexible.

The plates are typically formed from a rigid or substantially rigid material such as a plastic, metal, or hard rubber among other materials. In certain aspects, the plates or a portion of the plates may include a coating 80. Coating 80 may cover the entire plate or portions of the plate. The coating 80 may have various properties such as high friction, low friction, high durability or otherwise that may be beneficial for one or more plates or components of the plates.

The plates define a plurality of pin holes 30. The pin holes 30 are described generically as pin holes 30 throughout most of the specification for ease of description however the pin holes 30 may be further defined as first pin holes 30, second pin holes 30 and locking pin holes 30 to establish the respective first plate 12, second plate 14 and locking plate 16 in which the pin holes 30 are formed. The pin holes 30 extend through the plates between an upper surface and a lower surface of each plate. The pin holes 30 are configured with a size and shape that permits the shaft 28 of a pin 18 to be slidably received through the pin hole 30 when the plates are in an unlocked orientation. The pin holes 30 may have a circular, triangular, square, hexagonal, or other cross sectional shape as will be recognized by those skilled in the art upon review of the present disclosure. In certain aspects, the cross sectional shape of the pin hole 30 may correspond to the cross sectional shape of the shaft 28 of the pin 18. The hole axis 32 of each pin hole 30 is typically oriented parallel to the hole axes 32 of the other pin holes 30 in a particular plate. The hole axes 32 of the pin holes 30 may be substantially perpendicular to the plane defined by the associated plate. In certain aspects, the pin holes 30 may be arranged in a series of rows 34. The rows 34 may be linear, curved, circular or otherwise configured as will be recognized by those skilled in the art upon review of the present disclosure. The holes 30 may be arranged in a series of rows 34. The holes 30 may be spaced to permit the lower surface of each head 38 to rest on an upper surface of the adjacent plate. Typically, the holes 30 are spaced such that the edges of heads 38 of adjacent pins contact or nearly contact one another to form a substantially continuous surface.

The pin holes 30 in the locking plate 16 may, in certain aspects, be configured with a size and shape to permit more than one pin 18 to be received through each pin hole 30. In certain aspects, the pin holes 30 in the locking plate 16 may not correspond to the cross sectional shape of the shafts passing through the holes. For example, the pin holes 30 may be formed as slots, or asymmetrically such as in a tear-drop shape. In a tear-drop shape, the pin hole 30 may have one end with a radius of curvature substantially similar to the radius of the pin holes 30 of the other plates but with the other end having a smaller radius. The end with the smaller radius may receive the shaft 28 of the pin 18, frictionably engaging the shaft 28 when the locking plate 16 is in the locked position.

In certain aspects, each of the plates may be secured in a plane that is substantially parallel to the planes defined by the other plates. The first plate 12 and the second plate 14 are oriented so that a plurality of the pin holes 30 through the first plate 12 are aligned substantially coaxially with a plurality of the pin holes 30 through the second plate 14. One or more connectors 22 or other structures may be used to secure the relative position of the plates. The pins 18 extend through the pin hole 30 in the first plate 12 and then through the corresponding coaxial pin hole 30 in the second plate 14.

In certain aspects, the connectors 22 may be configured to relatively position at least two of the first plate 12, the second plate 14, and the locking plate 16. As generally illustrated throughout the figures, the connectors 22 may extend between at least the first plate 12 and the locking plate 16. When present, the connectors 22 may also extend between the second plate 14 and at least one of the first plate 12 and the locking plate 16. The connectors 22 may be configured to fix the relative positions of the first plate 12 and the second plate 14 when a second plate 14 is utilized.

The connectors 22 are generally configured to permit the locking plate 16 to be moved relative to at least the first plate 12 between at least a locked position and an unlocked position. Typically, the connectors 22 are configured to permit the movement of the locking plate 16 within the plane defined by the locking plate 16. When a second plate 14 is present, the first plate 12 and the second plate 14 may be at fixed relative positions with the locking plate 16 movable relative to both the first plate 12 and the second plate 14. In certain aspects, the locking plate 16 may include one or more mounting holes or other structures configured to slidably engage the connectors 22 or other structures so that the locking plate 16 may be moved between a locked and an unlocked position relative to the other plates. The mounting holes may be oblong or oversized to permit them to slidably engage the connectors 22. The mounting holes may engage the connectors by being received over a shaft of the connector 22, by being received within a slot of the connector 22, or otherwise as will be recognized by those of skill in the art upon review of the present disclosure.

In the unlocked position, the pin holes 30 of the locking plate 16 are generally aligned with the pin holes 30 of the first plate 12 and, when present, the second plate 14. The alignment is such that a pin may slide through a series of pin holes 30 through the first plate 12, second plate 14, when present, and the locking plate 16. In a locked position, the hole axes of the pin holes 30 in the locking plate 16 is offset from the pin holes 30 of the other plates. Accordingly, a lateral force is applied to the shaft 28 to secure the pins 18 at the desired position typically after an image is formed by the plurality of pins 18. The pins 18 may be secured by one or more of various frictional, mechanical and other interactions between the pins 18 and the plates. In certain embodiments, the shafts 28 of the pins 18 may be deformed to varying degrees by the offsetting of the pin holes 30 in the locking plate 16 to at least assist in securing the pins 18 positions.

One or more actuators 40 may move the locking plate 16 between at least the locked and the unlocked positions. The actuators 40 may include any of a variety of structures including various levers, cables, cams, motors, solenoids, threaded shafts, nuts, wheels, gears, cogs, sprockets, chains, mounts and the like either alone or in combination capable of moving the locking plate 16 between a locked and an unlocked position. In certain aspects, the actuator 40 may be secured to a lateral portion of the plate. The actuator 40 may move the locking plate 16 laterally within a plane defined by the locking plate 16. The actuator 40 may also retain the locking plate 16 in one of the locked or the unlocked position after moving it to the respective position.

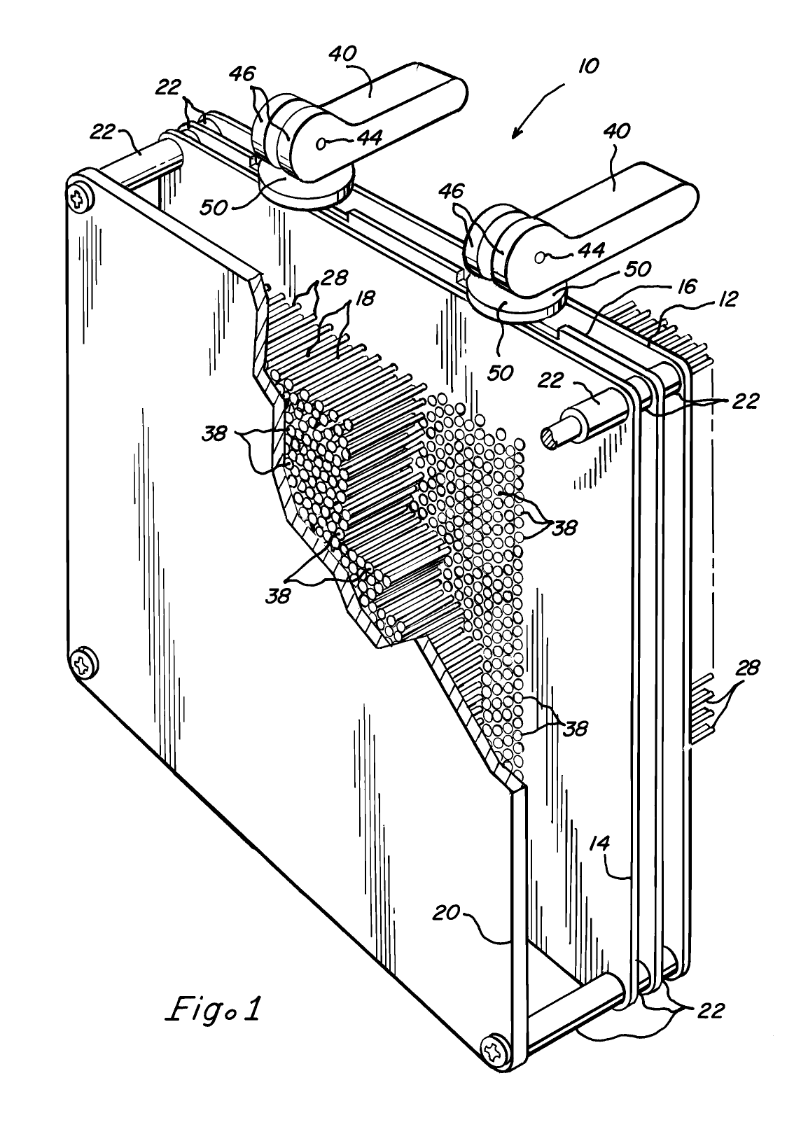

As particularly shown for exemplary purposes, FIG. 1 illustrates a perspective view of an embodiment of a pin imaging apparatus 10 in accordance with aspects of the present inventions. The illustrated embodiment includes a first plate 12, a second plate 14 and a locking plate 16. The locking plate 16 is secured between the first plate 12 and the second plate 14. Each of the first plate 12, the second plate 14 and the locking plate 16 are oriented substantially parallel to one another. The pins 18 extend through each of the first plate 12, the second plate 14 and the locking plate 16. A cover 20, in the form of a plate, is provided to retain the pins 18 within the holes 30 through the first plate 12, the second plate 14 and the locking plate 16 in a first direction. The cover 20, as illustrated, is typically formed from a transparent material so that the image formed by the pins 18 may be easily viewed. The heads 38 of the pins 18 are configured to retain pins 18 within the holes 30 in a second direction. The second direction is shown as opposite of the first direction along the hole axes 32 of the pin holes 30. The first plate 12, the second plate 14, the locking plate 16, and the cover 20 are secured to one another by connectors 22 positioned at the four corners of the illustrated components. As illustrated, the first plate 12, the second plate 14 and the cover 20 are secured at fixed positions relative to one another. The locking plate 16 is secured by the connectors 22 to the first plate 12, the second plate 14 and the locking plate 16 but is movable along at least one axis. As particularly illustrated, a first actuator 40 and a second actuator 40 are provided in the form of levers 40. The levers 40 are connected by shafts 42 (shown in FIG. 4) at a pivot point 44. A cam 46 is provided on the lever 40. The cam 44 slides over a surface of a support 50 when the lever is rotated about the pivot 44. The illustrated supports 50 bias against the first plate 12 and the second plate 14 as the levers 40 are rotated about pivot 44. The force of the levers 40 against the supports 50 is transferred to the shaft 42 (shown in FIG. 4) to move the locking plate 16 from a locked to an unlocked position depending on the direction the lever is moved.

As particularly shown for exemplary purposes, FIG. 2 illustrates a side view of another embodiment of a pin imaging apparatus 10 in accordance with aspects of the present inventions. The illustrated embodiment includes a first plate 12, a second plate 14 and a locking plate 16. The locking plate 16 is secured between the first plate 12 and the second plate 14. Each of the first plate 12, the second plate 14 and the locking plate 16 are oriented substantially parallel to one another. The pins 18 extend through each of the first plate 12, the second plate 14 and the locking plate 16. As illustrated, the pins 18 include a head 38 at both ends of shaft 28 to retain the pins 18 within the holes 30 through the first plate 12, the second plate 14 and the locking plate 16. The first plate 12, the second plate 14, and the locking plate 16 are secured to one another by connectors 22 positioned at the four corners of the illustrated components. As illustrated, the first plate 12 and the second plate 14 are secured at fixed positions relative to one another. The locking plate 16 is secured by the connectors 22 to the first plate 12, the second plate 14 and the locking plate 16 but is movable along at least one axis. As illustrated, the one axis is the plane defined by the locking plate 16. As illustrated, a first actuator 40 and a second actuator 40 are provided in the form of a threaded nut 40. The threaded nut 40 is threaded onto a threaded shaft 42. The threaded shaft 42 is secured to the locking plate 16. The threaded shaft 42 passes through a slot or hole in the support 50. The support 50 is secured to the connectors 22 to fix the relative position of the support 50 to the first plate 12 and the second plate 14. The threaded nut 40 is threaded over the threaded shaft 42. When rotated, the threaded nut 40 may move the locking plate 16 from a locked to an unlocked position depending on the direction the threaded nut 40 is rotated.

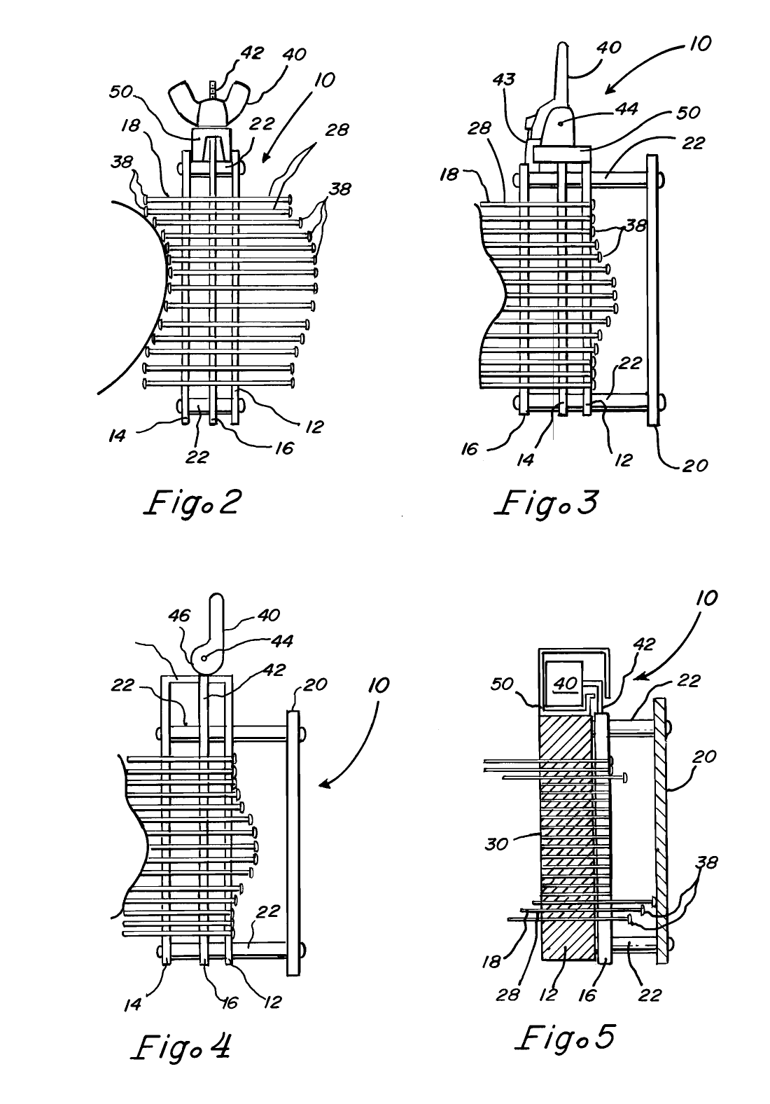

As particularly shown for exemplary purposes, FIG. 3 illustrates a side view of another embodiment of a pin imaging apparatus 10 in accordance with aspects of the present inventions. The illustrated embodiment includes a first plate 12, a second plate 14 and a locking plate 16. As illustrated, the first plate 12 and the second plate 14 are secured adjacent to one another and the locking plate 16 is secured to the end opposite of the end to which the cover 20 is secured. Each of the first plate 12, the second plate 14, the locking plate 16 and the cover 20 are oriented substantially parallel to one another. The pins 18 extend through each of the first plate 12, the second plate 14 and the locking plate 16. The cover 20 is provided to retain the pins 18 within the holes 30 through the first plate 12, the second plate 14 and the locking plate 16 in a first direction. The heads 38 of the pins 18 are configured to retain pins 18 within the holes 30 in a second direction. The second direction is shown as opposite of the first direction along the axes 32 of the holes 30. The first plate 12, the second plate 14, the locking plate 16, and the cover 20 are secured to one another by connectors 22 positioned at the four corners of the illustrated components. As illustrated, the first plate 12, the second plate 14 and the cover 20 are secured at fixed positions relative to one another. The locking plate 16 is secured by the connectors 22 to the first plate 12, the second plate 14 and the locking plate 16 but is movable along at least one axis between a locked position and an unlocked position. As illustrated, the one axis is the plane defined by the locking plate 16. As illustrated, the actuator 40 is provided in the form of lever 40. The lever 40 is secured to a support 50 secured to the first plate 12 and the second plate 14. The lever 40 is connected by a cable 43 to the locking plate 16. The lever 40 rotates about the pivot 44 placing tension on the cable 43 through support 50 when moved from an unlocked position to a locked position (Shown in phantom). When the lever 40 is moved from a locked to an unlocked position, the force applied to the cable 43 is relieved and the locking plate 16 may tend toward an unlocked position relative to the first plate 12 and the second plate 14.

As particularly shown for exemplary purposes, FIG. 4 illustrates a side view of another embodiment of a pin imaging apparatus 10 in accordance with aspects of the present inventions. The illustrated embodiment includes a first plate 12, a second plate 14 and a locking plate 16. The locking plate 16 is secured between the first plate 12 and the second plate 14. Each of the first plate 12, the second plate 14 and the locking plate 16 are oriented substantially parallel to one another. The pins 18 extend through each of the first plate 12, the second plate 14 and the locking plate 16. A cover 20, in the form of a plate, is provided to retain the pins 18 within the holes 30 through the first plate 12, the second plate 14 and the locking plate 16 in a first direction. The heads 38 of the pins 18 are configured to retain pins 18 within the holes 30 in a second direction. The second direction is shown as opposite of the first direction along the axes 32 of the holes 30. The first plate 12, the second plate 14, the locking plate 16, and the cover 20 are secured to one another by connectors 22 positioned at the four corners of the illustrated components. As illustrated, the first plate 12, the second plate 14 and the cover 20 are secured at fixed positions relative to one another. The locking plate 16 is secured by the connectors 22 to the first plate 12, the second plate 14 and the locking plate 16 but is movable along at least one axis. As illustrated, the one axis is the plane defined by the locking plate 16. As illustrated, an actuator 40 is provided in the form of a lever 40. The lever 40 is connected by shafts 42 at a pivot point 44. A cam 46 is provided on the lever 40. The cam 44 slides over a surface of a support 50 when the lever is rotated about the pivot 44. The illustrated support 50 is integral with the first plate 12 and the second plate 14. The force of the lever 40 against the support 50 is transferred to the shaft 42 and moves the locking plate 16 from a locked to an unlocked position depending on the direction the lever 40 is moved.

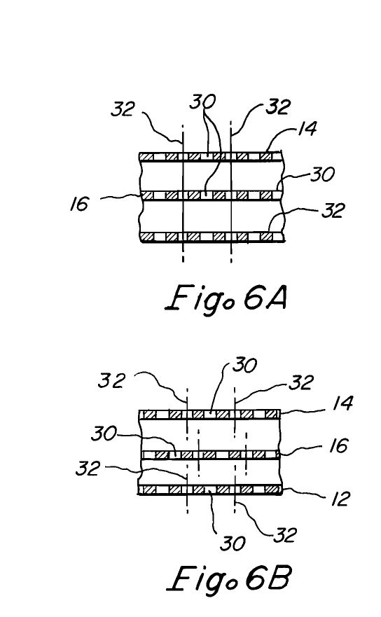

As particularly shown for exemplary purposes, FIG. 5 illustrates a side view of another embodiment of a pin imaging apparatus 10 in accordance with aspects of the present inventions. The illustrated embodiment includes a first plate 12 and a locking plate 16. The locking plate 16 is secured between the first plate 12 and a cover 20. The first plate 12 and the locking plate 16 are oriented substantially parallel to one another. The pins 18 extend through each of the first plate 12 and the locking plate 16. The cover 20 retains the pins 18 within the holes 30 through the first plate 12 and the locking plate 16 in a first direction. The heads 38 of the pins 18 are configured to retain pins 18 within the holes 30 in a second direction. The second direction is shown as opposite of the first direction along the axes 32 of the pin holes 30. The first plate 12, the locking plate 16, and the cover 20 are secured to one another by connectors 22 positioned at the four corners of the illustrated components. As illustrated, the first plate 12 and the cover 20 are secured at fixed positions relative to one another. The locking plate 16 is secured by the connectors 22 between the first plate 12 and the locking plate 16 but is movable along at least one axis. As illustrated, the one axis is the plane defined by the locking plate 16. An actuator 40 is provided in the form of a motor 40. The motor 40 is secured within a housing 50 which is secured at a fixed position relative to the first plate 12. The motor 40 is operably connected by a shaft 42 to move the locking plate 16 from an unlocked position to a locked position. The illustrated housing 50 is secured to the first plate 12. The force of the motor 40 is transferred through the shaft 42 to move the locking plate 16 from a locked to an unlocked position.

As particularly shown for exemplary purposes, FIGS. 6A and 6B illustrate an exemplary positional relationship for a first plate 12, a second plate 14 and a locking plate 16 in an unlocked position and a locked position, respectively in accordance with aspects of the present inventions. As shown in FIG. 6A, the hole axes 32 of first holes 30 of the first plate 12, the hole axes 32 of the locking holes 30 of the locking plate 16 and the hole axes 32 of the second holes of the second plate 14 are substantially coaxial. In such an unlocked position, the shaft 28 of a pin 18 extending through an aligned series of a first hole 30, a locking hole 30 and a second hole 30 may be configured to have a shaft 18 movably received. As shown in FIG. 6B, the hole axes 32 of first holes 30 and the hole axes 32 of the second holes are substantially coaxial. The hole axes 32 of the locking holes 30 are offset. In such a locked position, the shaft 28 of a pin 18 extending through a substantially aligned series of a first hole 30, a locking hole 30 and a second hole 30 where the locking hole 30 is offset may be configured to have a shaft 18 secured at the position it is in when the locking plate is moved from the unlocked position to the locked position. Depending on the particular configuration of the pins 18 and holes 30, the pin may be secured at a desired position by one or more of mechanical and frictional forces among other interactions.

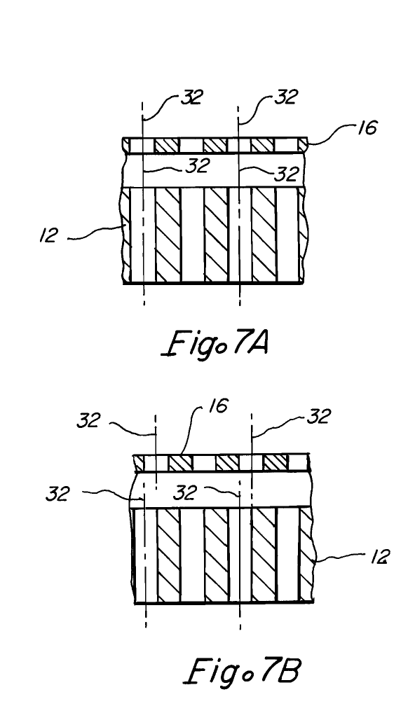

As particularly shown for exemplary purposes, FIGS. 7A and 7B illustrate an exemplary positional relationship for a first plate 12 and a locking plate 16 in an unlocked position and a locked position, respectively in accordance with aspects of the present inventions. As shown in FIG. 7A, the hole axes 32 of first holes 30 of the first plate 12 and the hole axes 32 of the locking holes 30 of the locking plate 16 are substantially coaxial. In such an unlocked position, the shaft 28 of a pin 18 extending through an aligned series of a first hole 30 and a locking hole 30 may be configured to have a shaft 18 movably received. As shown in FIG. 7B, the hole axes 32 of first holes 30 and the hole axes 32 of the locking holes 30 are offset. In this locked position, a shaft 28 of a pin 18 extending through a substantially aligned series of a first hole 30 and a locking hole 30 where the locking hole 30 is offset may be configured to have a shaft 18 secured at the position it is in when the locking plate is moved from the unlocked position to the locked position. Depending on the particular configuration of the pins 18 and holes 30, the pin may be secured at a desired position by one or more of mechanical and frictional forces among other interactions.

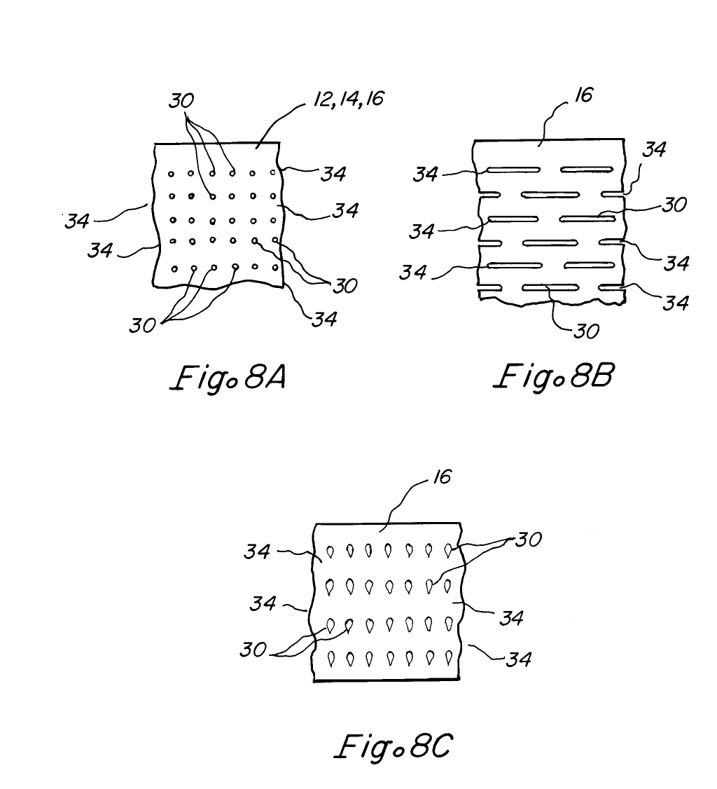

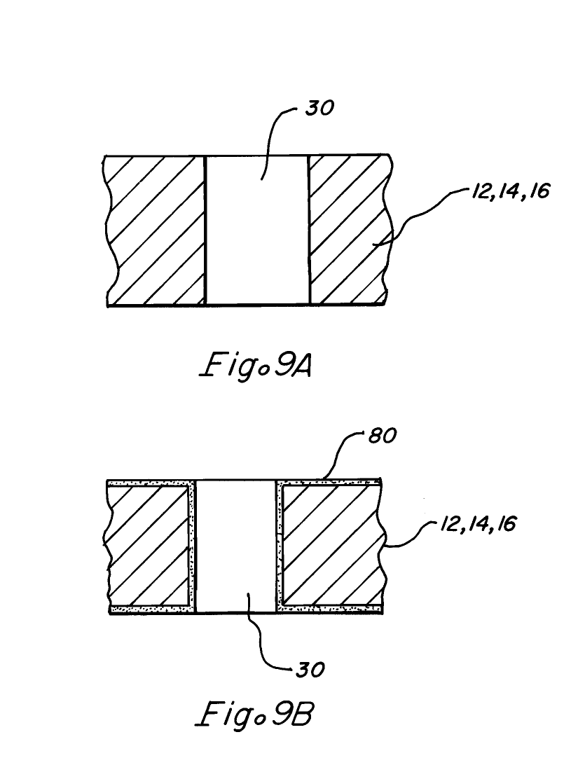

As particularly shown for exemplary purposes, FIGS. 8A, 8B and 8C illustrate an exemplary configuration for holes 30 in accordance with aspects of the present inventions. FIG. 8A illustrates a top view of a portion of a plate having holes 30 extending from a first surface to a second surface of the plate. The illustrated holes 30 have a substantially circular cross section. The holes 30 are arranged in a set of rows 34 extending laterally (and vertically) as illustrated. FIG. 8B illustrates a pin hole 30 in the shape of a slot. The slots are arranged in a set of rows 34 extending laterally as illustrated. The slot may be configured to retain two or more shafts 28 along its length. As illustrated, the locking plate 16 having the slots would move along an axis oriented up and down (as drawn) to engage the one or more pins 18 extending through each slot. FIG. 8C illustrates a pin hole 30 having a tear-drop shape. The holes 30 are arranged in a set of rows 34 extending laterally (and vertically) as illustrated. The pin hole 30 may have one end with a radius of curvature substantially similar to the radius of the pin holes 30 of the other plates but with the other end having a smaller radius or coming to a point. The end with the smaller radius may receive the shaft 28 of the pin 18, frictionally engaging the shaft 28 when the locking plate 16 is in the locked position.

As particularly shown for exemplary purposes, FIGS. 9A and 9B illustrate an exemplary configuration for a plate and a pin hole 30 in accordance with aspects of the present inventions. FIG. 9A illustrates a plate formed from a unitary material. FIG. 9B illustrates a plate formed from a base material with a coating 80 applied over an upper surface and a lower surface of the plate as well as along the walls defining the hole 30.

In operation, the pins 18 are oriented with their heads adjacent to a surface of a plate with the locking plate 16 in an unlocked position such that the pin holes 30 of the locking plate 16 and at least a first plate 12 are aligned. Typically, the pins 18 are forced by orienting the pin imaging apparatus 10 in a horizontal orientation to allow gravity to force the pins 18 downward until a head contacts the upper surface of an adjacent plate. The pin imaging apparatus 10 is then rotated to a horizontal position. An object 100 is then positioned against the second ends of the pins 18 and is moved into the pins 18 to displace the heads 38 and shafts outward away from the upper surface of the adjacent plate to form a three dimensional pin image of the portion of the object contacting the second end of the pins 18. The locking plate 16 is then moved from an unlocked position to a locked position by offsetting the locking pin holes 30 of the locking plate 16 and at least the first pin holes 30 of the first plate 12. In some embodiments, the locking plate 16 is moved from an unlocked position to a locked position by offsetting the locking pin holes 30 of the locking plate 16, so that the pins 18 may be bent, deformed, curved and/or flexed and locked in the desired position to retain the three dimensional pin image of the portion of the object that contacted and moved into the pins 18.

The foregoing discussion discloses and describes merely exemplary embodiments of the present inventions. Upon review of the specification, one skilled in the art will readily recognize from such discussion, and from the accompanying figures and claims, that various changes, modifications and variations can be made therein without departing from the spirit and scope of the invention as defined in the following claims.

What is claimed is:

1. An apparatus for forming an impression of an object, comprising:
a first plate secured to a second plate at a fixed relative position, the first plate defining a plurality of first holes, the second plate defining a plurality of second holes, the plurality of first holes coaxially aligned with the plurality of second holes;
a plurality of pins positioned through the plurality of first holes and the plurality of second holes, each of the pins comprising a shaft and a head, the head positioned at a first end of the shaft, the shafts extending through the plurality of first holes and the plurality of second holes, a second end of the shaft configured to contact an object and to displace the shaft relative to the object such that the heads of the pins to form a corresponding image of the object; and
a locking plate movably secured to the first plate and the second plate, the locking plate movable between at least a locked position and an unlocked position, the locking plate defining a plurality of locking holes, the shafts of the plurality of pins extending through the plurality of locking holes, the plurality of locking holes is aligned with the plurality of first holes and the plurality of second holes when the locking plate is in the unlocked position and the plurality of locking holes is offset from the plurality of first holes and the plurality of second holes when the locking plate is in the locked position to secure the plurality of pins and to retain the corresponding image of the object.

2. An apparatus for forming an impression of an object, comprising:
a first plate defining a plurality of holes;
a plurality of pins positioned within the plurality of holes, each of the pins comprising a shaft and a head, the head positioned at a first end of the shaft, each shaft extending through at least one of the plurality of holes, a second end of the shaft configured to contact an object and to displace the shaft relative to the object such that the heads of the pins to form an image of the object; and
a locking plate movably secured to the first plate, the locking plate movable between at least a locked position and an unlocked position, the locking plate defining a plurality of locking holes, the shafts of the plurality of pins extending through at least one of the plurality of locking holes, the plurality of holes is aligned with the plurality of locking holes when the locking plate is in the unlocked position to permit the pins to be positioned when contacted by an object at the second end of the shaft and the plurality of locking holes is offset from the plurality of holes when the locking plate is in the locked position to secure the plurality of pins and to retain an image of the object.
